(19) United States
(12) Patent Application Publication
(10) Pub. No.: US 2026/0226743 A1
(43) Pub. Date: Aug. 6, 2026

(54) ROOFING PRODUCTS WITH IMPROVED TEAR STRENGTH

(71) Applicant: Owens Corning Intellectual Capital, LLC, Toledo, OH (US)

(72) Inventors: William Edwin Smith, Pataskala, OH (US); Nardine Said Abadeer, Columbus, OH (US); Sunil Hiralal Jinandra, Powell, OH (US); Ryan Robert Salata, Westerville, OH (US); Peter Bernard McGinnis, Gahanna, OH (US); Brian Frederick Shaeffer, Pataskala, OH (US); Stephanie Ann Pruzinsky, Newark, OH (US)

(21) Appl. No.: 19/529,217

(22) Filed: Feb. 4, 2026

Related U.S. Application Data
(60) Provisional application No. 63/754,201, filed on Feb. 5, 2025.

(51) Int. Cl. E04D 1/20; C09D 195/00; D04H 1/4218; D04H 1/58; D06N 5/00

(52) U.S. Cl. CPC E04D 1/20; C09D 195/00; D04H 1/4218; D04H 1/58; D06N 5/003; D06N 2201/082; D06N 2209/103; D10B 2505/20

(57) ABSTRACT

Various aspects are directed to roofing shingles and roofing underlayments comprising a nonwoven mat comprising a plurality of glass fibers having a specific toughness greater than or equal to 45 kPa/(kg/m³) bound together by a binder and an asphalt shingle coating composition applied to at least one side of the nonwoven mat. The roofing shingles and roofing underlayments exhibit an improvement in cross-direction (CD) tear resistance as compared to an otherwise identical roofing product having a nonwoven mat comprising a plurality of glass fibers having a specific toughness of less than 45 kPa/(kg/m³).

### CROSS-REFERENCE TO RELATED APPLICATIONS

This application claims priority to and all benefit of U.S. Provisional Patent Application No. 63/754,201, filed on Feb. 5, 2025, the entire disclosure of which is fully incorporated herein by reference.

### BACKGROUND

Asphalt-based roofing materials, such as roofing shingles, roofing underlayments, roll roofing and commercial roofing, are installed on the roofs of buildings to provide protection from the elements, and to provide a pleasing aesthetic appearance. Roofing material is often constructed of a substrate such as a glass fiber mat or an organic felt, an asphalt coating on the substrate, and, optionally, a surface layer of granules embedded in the asphalt coating.

A common method for the manufacture of asphalt shingles is the production of a continuous sheet of asphalt material followed by a shingle cutting operation which cuts the material into individual shingles. In the production of asphalt sheet material, either a glass fiber mat or an organic felt mat is passed through a coater containing hot liquid asphalt to form a tacky, asphalt coated sheet. Subsequently, the hot asphalt coated sheet is passed beneath one or more granule applicators which discharge protective and decorative surface granules onto portions of the asphalt sheet material.

Roofing shingles may be designed to meet a variety of different performance characteristics, including resistance to damage from fire, impact and wind. Tear strength is one particularly important characteristic, as it measures how easily a shingle is torn. Tear strength is also correlated to resistance to cracking. Accordingly, alternative roofing products that exhibit improved tear strength are desirable.

### BRIEF SUMMARY

Various aspects described herein are directed to roofing shingles comprising a nonwoven mat comprising a plurality of glass fibers having a specific toughness greater than or equal to 45 kPa/(kg/m³) bound together by a binder and an asphalt shingle coating composition applied to at least one side of the nonwoven mat. In aspects, the roofing shingle has an improvement in cross-direction (CD) tear resistance, as measured in accordance with ASTM D1922 as modified by ASTM D228, of at least 100 grams-force as compared to an otherwise identical shingle having a nonwoven mat comprising a plurality of glass fibers having a specific toughness of less than 45 kPa/(kg/m³). Additionally or alternatively, the roofing shingle has an improvement in cross-direction (CD) tear resistance, as measured in accordance with ASTM D1922 as modified by ASTM D228, of at least 5% as compared to an otherwise identical shingle having a nonwoven mat comprising a plurality of glass fibers having a specific toughness of less than 45 kPa/(kg/m³). In some aspects, the roofing shingle has a cross-direction (CD) tear resistance of greater than or equal to about 1,800 grams-force, as measured in accordance with ASTM D1922 as modified by ASTM D228.

In any of the aspects herein, the asphalt shingle coating composition comprises non-oxidized asphalt or polymer modified asphalt. In aspects, the plurality of glass fibers have a Young's modulus of at least about 85 GPa. In any of the aspects disclosed herein, the plurality of glass fibers have a specific modulus of from about 32 MJ/kg to about 37 MJ/kg. In aspects, the plurality of glass fibers have a density of from about 2.0 g/cc to about 3.0 g/cc, measured in accordance with ASTM C-693-63. In aspects, the plurality of glass fibers have a specific strength of greater than or equal to about 1.70 MPa/(kg/m³).

In aspects, the roofing shingle has a CD tear resistance of greater than or equal to about 2,000 grams-force, an improvement in stiffness of at least 5% or at least 10%, as measured by dynamic mechanical analysis, as compared to an otherwise identical shingle having a nonwoven mat comprising a plurality of glass fibers having a specific toughness of less than 45 kPa/(kg/m³).

In any of the aspects, the roofing shingle may have an improvement in nail pull through strength of greater than or equal to 15% or greater than equal to 20% measured in accordance with ASTM D3462 at 73° F., as compared to an otherwise identical shingle having a nonwoven mat comprising a plurality of glass fibers having a specific toughness of less than 45 kPa/(kg/m³). In aspects, the roofing shingle has an improvement in nail pull through strength of greater than or equal to 5% measured in accordance with ASTM D3462 at 32° F., as compared to an otherwise identical shingle having a nonwoven mat comprising a plurality of glass fibers having a specific toughness of less than 45 kPa/(kg/m³).

In aspects, the roofing shingle has an improvement in Charpy impact resistance of greater than or equal to 20% measured in accordance with ASTM D6110 in the cross-direction at 73° F. on unnotched specimens, as compared to an otherwise identical shingle having a nonwoven mat comprising a plurality of glass fibers having a specific toughness of less than 45 kPa/(kg/m³). The roofing shingle of any of the aspects disclosed herein can additionally or alternatively have an improvement in machine direction (MD) tensile strength of greater than or equal to 5% measured according to a modified ASTM D828 on a 2-inch wide by 10-inch long sample tested at 2 inches per minute, as compared to an otherwise identical shingle having a nonwoven mat comprising a plurality of glass fibers having a specific toughness of less than 45 kPa/(kg/m³).

In aspects, the roofing shingle has an improvement in impact resistance of greater than or equal to 5% measured according to UL2218, as compared to an otherwise identical shingle having a nonwoven mat comprising a plurality of glass fibers having a specific toughness of less than 45 kPa/(kg/m³). In any of the aspects disclosed herein, the roofing shingle may have an improvement in cross-direction Gurley stiffness of greater than or equal to 5% as compared to an otherwise identical shingle having a nonwoven mat comprising a plurality of glass fibers having a specific toughness of less than 45 kPa/(kg/m³).

According to aspects, a method of manufacturing a roofing shingle comprising applying an asphalt shingle coating composition to at least one surface of a nonwoven mat, thereby forming an asphalt-coated sheet, the nonwoven mat comprising a plurality of glass fibers having a specific toughness greater than or equal to 45 kPa/(kg/m³) bound together by a binder. The resulting roofing shingle may be the shingle of any of the previous aspects.

According to aspects of the disclosure, a roofing underlayment comprises a nonwoven mat at least partially impregnated with asphalt, wherein the nonwoven mat comprises a plurality of glass fibers having a specific toughness greater than or equal to 45 kPa/(kg/m³) bound together by a binder. The roofing underlayment has an improvement in cross-direction (CD) notched tear resistance, as measured in accordance with ASTM D1970, of at least 15% as compared to an otherwise identical roofing underlayment having a nonwoven mat comprising a plurality of glass fibers having a specific toughness of less than 45 kPa/(kg/m³).

In some aspects, the roofing underlayment has an improvement in machine-direction (MD) notched tear resistance, as measured in accordance with ASTM D1970, of at least 15% or at least 30% as compared to an otherwise identical roofing underlayment having a nonwoven mat comprising a plurality of glass fibers having a specific toughness of less than 45 kPa/(kg/m³).

In aspects, the roofing underlayment has an improvement in cross-direction (CD) tensile elongation, as measured in accordance with ASTM D1970, of at least 15% as compared to an otherwise identical roofing underlayment having a nonwoven mat comprising a plurality of glass fibers having a specific toughness of less than 45 kPa/(kg/m³).

According to any of the aspects disclosed herein, the plurality of glass fibers of the roofing underlayment may have a Young's modulus of at least about 85 GPa, a specific modulus of from about 32 MJ/kg to about 37 MJ/kg, a density of from about 2.0 g/cc to about 3.0 g/cc, measured in accordance with ASTM C-693-63, and/or a specific strength of greater than or equal to about 1.70 MPa/(kg/m³).

In yet another aspect, a method of manufacturing a roofing underlayment comprises at least partially impregnating a nonwoven mat with asphalt, thereby forming an asphalt-coated sheet, the nonwoven mat comprising a plurality of glass fibers having a specific toughness greater than or equal to 45 kPa/(kg/m³) bound together by a binder. The resulting roofing underlayment may be the roofing underlayment of any of the previous aspects.

### DETAILED DESCRIPTION

Several illustrative aspects will be described in detail with the understanding that the present disclosure merely exemplifies the general inventive concepts. Aspects encompassing the general inventive concepts may take various forms and the general inventive concepts are not intended to be limited to the specific aspects described herein.

Disclosed herein are roofing materials comprising a nonwoven mat and an asphalt coating applied to at least one side of the nonwoven mat. The nonwoven mat comprises a plurality of glass fibers having a specific toughness greater than or equal to 45 kPa/(kg/m³) bound together by a binder. The specific toughness of the glass fibers of the nonwoven mat result in the roofing product having an improvement in cross-direction (CD) tear resistance, as compared to an otherwise identical roofing product having a nonwoven mat comprising a plurality of glass fibers having a specific toughness of less than 45 kPa/(kg/m³) (also referred to herein as the “comparable roofing product”). The improvement may be an improvement in CD tear resistance of at least 100 grams-force and/or at least 5% greater CD tear resistance than the comparable roofing product.

The terminology as set forth herein is for description only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use.

All combinations of method or process steps as used herein can be performed in any order, unless otherwise specified or clearly implied to the contrary by the context in which the referenced combination is made.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

The methods of the present disclosure can comprise, consist of, or consist essentially of the essential elements of the disclosure as described herein, as well as any additional or optional element described herein, or which is otherwise useful in roofing applications.

### Asphalt Coating Compositions

The asphalt coating composition comprises an asphalt base material, or base asphalt, which is understood to mean any asphalt base material composed of one or more asphalt bases and optionally comprising one or more additives. As used herein, the term “asphalt” is meant to include any bituminous materials produced from petroleum refining, including residua from atmospheric distillation, from vacuum distillation, from solvent de-asphalting units, and from recycled asphalt streams, such as re-refined motor oil bottoms and extracted asphalt from recycled asphalt shingles. Mixtures of different asphalts can also be used. Some aspects disclosed herein can also be used with natural bitumen, such as the products extracted from oil sands in Alberta or asphalts derived from oil sands by various refinery processes.

The base asphalt may be visbroken and/or deasphalted (i.e., propane deasphalted asphalt) and/or partially or fully oxidized. In some aspects, the base asphalt may be prepared using a wide array of paving grade asphalt materials, such as different types of paving asphalts used independently or as a mixture with various types of asphalt, such as, for example, solvent extracted asphalt, naturally occurring asphalt, synthetic asphalt, and recycled asphalt. The various asphalt bases can be combined with one another in order to obtain the best technical compromise.

The base asphalt may comprise one or more of flux, paving grade asphalt or paving grade asphalt blends, propane deasphalted asphalt, partially or fully oxidized asphalt, non-oxidized asphalt, polymer-modified asphalt and/or blends thereof. By “paving grade asphalt,” as used herein, is meant a performance grade asphalt according to AASHT20 17320-17 that has a softening point within the range of about 60° F. to about 130° F. and a penetration value of at least about 25 decimillimeter (dmm). Paving grade asphalts are not typically used in roofing applications because such asphalts are not able to achieve the properties required to be considered “coating grade” asphalt, as defined by ASTM D 3462-16: a softening point minimum of from 190° F. (88° C.) to 235° F. (113° C.) and a penetration at 77° F. (25° C.) and a minimum of 15 dmm.

The asphalt material used in the asphalt coating composition may include at least one type of paving-grade asphalt. Any suitable paving-grade asphalt(s) can be used, for example paving asphalts which meet the PG 64-22 specifications (AASHTO M320 or AASHTO M332). PG 64-22 is the most common paving specification in the United States. Paving asphalts were previously graded by viscosity and a common asphalt that is similar to the PG 64-22 grade asphalt and also usable in this method, is the old AC20 grade asphalt (ASTM D 3381). Other examples of suitable paving-grade asphalts include PG 67-22, PG 70-22, PG 58-22, PG 58-28, PG 58-22, PG 70-16, PG 70-10, PG 67-10, pen grade 40/50, pen grade 60/70, pen grade 85/100, pen grade 120/150, AR4000, AR8000, and AC/30 grade.

The base asphalt may be included in the asphalt coating composition in an amount of from about 10 wt. % to about 80 wt. %, based on the weight of the asphalt coating composition. For example, the asphalt coating composition may include from about 10 wt. % to about 80 wt. %, from about 20 wt. % to about 80 wt. %, from about 30 wt. % to about 80 wt. %, from about 40 wt. % to about 80 wt. %, from about 50 wt. % to about 80 wt. %, from about 60 wt. % to about 80 wt. %, from about 10 wt. % to about 70 wt. %, from about 20 wt. % to about 70 wt. %, from about 30 wt. % to about 70 wt. %, from about 40 wt. % to about 70 wt. %, from about 50 wt. % to about 70 wt. %, from about 60 wt. % to about 70 wt. %, from about 10 wt. % to about 60 wt. %, from about 20 wt. % to about 60 wt. %, from about 30 wt. % to about 60 wt. %, from about 40 wt. % to about 60 wt. %, from about 50 wt. % to about 60 wt. %, from about 10 wt. % to about 50 wt. %, from about 20 wt. % to about 50 wt. %, from about 30 wt. % to about 50 wt. %, or from about 40 wt. % to about 50 wt. %, of the base asphalt, including all endpoints and subranges therebetween, based on the total weight of the asphalt coating composition.

The asphalt base material may optionally further comprise at least one polymer additive and/or at least one fluxing agent. The polymer additive may comprise an elastomeric radial or linear polymer. The polymer additive may comprise a copolymer such as a linear or radial copolymer. In some embodiments the polymer additive comprises one or more of atactic polypropylene (APP), isotactic polypropylene (IPP), styrene-butadiene-styrene rubber (SBS), polychloroprene; polynorbornene; chloroprene rubber (CR), natural and reclaimed rubbers (including ground tire rubber (GTR) and depolymerized ground tire rubber), butadiene rubber (BR), acrylonitrile-butadiene rubber (NBR), isoprene rubber (IR), styrene-polyisoprene (SI), butyl rubber, ethylene propylene rubber (EPR), ethylene propylene diene monomer rubber (EPDM), polyisobutylene (PIB), chlorinated polyethylene (CPE), styrene ethylene-butylene-styrene (SEBS), hydrogenated SBS, vinylacetate/polyethylene (EVA), ethylene-methylacrylate copolymers (EMA), copolymers of olefins and unsaturated carboxylic esters such as ethylene-butylacrylates (EBA), polyolefinic copolymers, polyolefins such as polybutenes (PB), copolymers of ethylene and esters of acrylic acid or methacrylic acid or maleic anhydride, copolymers and terpolymers of ethylene and glycidyl methacrylate, ethylene/propylene copolymers, rubber, and mixtures thereof. In other exemplary embodiments, the polymer additive comprises a linear polymer or a combination of linear and radial polymers. Examples of polymer modifiers are also disclosed in U.S. Pat. No. 4,738,884 to Algrim et al., U.S. Pat. No. 3,770,559 to Jackson, and 11,028,591 to LaTorre et al., the contents of which are incorporated herein by reference in their entirety. In some exemplary embodiments, the asphalt is modified with styrene-butadiene-styrene rubber (SBS).

The polymer additive may be included in the asphalt base material in an amount from about 0.5 wt. % to about 15.0 wt. %, based on the weight of the asphalt coating composition. The polymer additive may be included in an amount from about 1.0 to about 15.0 wt. %, or from about 1.5 to about 10.0 wt. %, or from about 2.0 to about 7.0 wt. %, or from about 3.0 to about 6.5 wt. %, or about 5.0 to about 6.0 wt. %, based on the weight of the asphalt coating composition. However, it is contemplated that, in some aspects, the asphalt base material does not include a polymer additive.

The asphalt coating composition may optionally further include a filler material. The filler material may be included in an amount of from greater than 0 wt. % to about 70 wt. %. For example, the filler may be included in the asphalt coating composition in an amount of from greater than 0 wt. % to about 70 wt. %, from greater than 0 wt. % to about 60 wt. %, from greater than 0 wt. % to about 50 wt. %, from greater than 0 wt. % to about 40 wt. %, from greater than 0 wt. % to about 30 wt. %, from about 10 wt. % to about 70 wt. %, from about 10 wt. % to about 60 wt. %, from about 10 wt. % to about 50 wt. %, from about 10 wt. % to about 40 wt. %, from about 10 wt. % to about 30 wt. %, from about 20 wt. % to about 70 wt. %, from about 20 wt. % to about 60 wt. %, from about 20 wt. % to about 50 wt. %, from about 20 wt. % to about 40 wt. %, from about 20 wt. % to about 30 wt. %, from about 30 wt. % to about 70 wt. %, from about 30 wt. % to about 60 wt. %, from about 30 wt. % to about 50 wt. %, from about 30 wt. % to about 40 wt. %, from about 40 wt. % to about 70 wt. %, from about 40 wt. % to about 60 wt. %, from about 40 wt. % to about 50 wt. %, from about 50 wt. % to about 70 wt. %, or from about 50 wt. % to about 60 wt. %, including all endpoints and subranges therebetween.

The filler material may include particles comprising any variety of ground inorganic particulate matter, such as, for example, ground limestone, dolomite or silica, talc, sand, cellulosic materials, fiberglass, calcium carbonate, clay, carbon, perlite, mica, fumed silica, carbon black, wollastonite, and combinations thereof. The filler material may comprise particles having an average (median) particle size in the range of 0.3 microns to 200 microns, including an average particle size range of 1 micron to 180 microns, 5 microns to 175 microns, 15 microns to 150 microns, 25 microns to 125 microns, 30 microns to 115 microns, 35 microns to 100 microns, 40 microns to 85 microns, and 45 microns to 60 microns, including all endpoints and subranges therebetween.

In various aspects, other additives can be incorporated into the asphalt coating composition to modify one or more properties of the base asphalt. Additives can include, by way of example and not limitation, polymers, rubbers, waxes, hardeners, softeners, and any of type of additive known and used in the art for modification of asphalt coating compositions for roofing applications. For example, additives can be used to modify the penetration value, the softening point, and/or the viscosity of the asphalt coating composition as compared to the base asphalt. Accordingly, because the additives that are incorporated into the asphalt coating composition are effective to modify one or more properties of the base asphalt, the asphalt coating composition of various aspects may be suitable for use as a coating, such as a coating on a roofing material.

### Nonwoven Mats

The asphalt coating composition is applied to at least one side of a substrate, which in various aspects, is a nonwoven mat. In general, the nonwoven mat comprises a plurality of glass fibers that are bound together by a binder. The binder is not generally limited and can be, for example, any type of binder conventionally used in the formation of nonwoven mats and roofing materials. In various aspects, the binder composition generally comprises a binder resin material, a coupling agent, a wetting agent, and one or more optional additives.

For example, the binder composition may include a thermoset material, a thermoplastic material, or a mixture of a thermoset material and a thermoplastic material. The thermoset material may comprise, for example, an acrylic material, a urea formaldehyde material, or a combination of the two materials. In any of the aspects disclosed herein, the binder resin may be present in the binder composition in an amount of 90% to 99% based on the total weight of the binder composition. In aspects, the binder resin may be present in the binder composition in an amount of 97% to 99% based on the total weight of the binder composition.

In various aspects, the glass fibers of the nonwoven mat are formed from a high-performance glass composition with high specific toughness. In particular, it has been surprisingly found that the use of a nonwoven mat formed from glass fibers with a specific toughness of greater than or equal to 45 kPa/(kg/m³) can produce roofing products having improved performance properties. Toughness is a material's ability to resist cracking under stress or absorb energy. Although strength and toughness are often related, strength measurement is the highest stress a fiber can handle while toughness is measured on how much the material can give before deforming. The specific toughness is determined by calculating the area under a stress strain curve from the testing start measured to the point of failure, divided by the fiber's density. Accordingly, in various aspects, the glass fibers of the nonwoven mat have a specific toughness of greater than or equal to 45.0 kPa/(kg/m³), greater than or equal to 45.5 kPa/(kg/m³), greater than or equal to 46.0 kPa/(kg/m³), greater than or equal to 46.5 kPa/(kg/m³), or greater than or equal to 47.0 kPa/(kg/m³).

As set forth above, strength and toughness are often related. Accordingly, in some aspects, the glass fibers also have a relatively high tensile strength. The fiber tensile strength is also referred to herein simply as “strength.” As used herein, tensile strength is measured on pristine fibers (i.e., unsized and untouched laboratory produced fibers) using an Instron tensile testing apparatus according to ASTM D2343-09. The glass fibers useful in the present invention have a fiber tensile strength of at least 3,500 MPa, including at least 4,000 MPa, at least 4,500 MPa, at least 4,800 MPa, at least 4,900 MPa, at least 4,950 MPa, at least 5,000 MPa, at least 5,100 MPa, at least 5,150 MPa, and at least 5,200 MPa. In some aspects, the glass fibers have a fiber tensile strength of from about 3500 to about 5500 MPa, including about 4000 MPa to about 5,300, about 4,600 to about 5,250 MPa.

The specific strength of a glass fiber may be determined by dividing the tensile strength by the density. In some aspects, the glass fibers of the nonwoven mat have a specific strength of greater than or equal to about 1.70 MPa/(kg/m³), such as greater than or equal to about 1.75 MPa/(kg/m³), or greater than or equal to 1.80 MPa/(kg/m³).

The Young's modulus (also referred to as elastic modulus) of a glass fiber may be determined by taking the average measurements on five single glass fibers measured in accordance with the sonic measurement procedure outlined in the report “Glass Fiber and Measuring Facilities at the U.S. Naval Ordnance Laboratory”, Report Number NOLTR 65-87, Jun. 23, 1965.

The glass fibers useful in the present invention have a Young's modulus of at least about 85 GPa, including at least about 88 GPa, at least about 88.5 GPa, at least about 89 GPa, and at least about 89.5 GPa. In some aspects, the exemplary glass fibers have a Young's modulus of between about 85 GPa and about 95 GPa, including between about 87 GPa and about 92 GPa, and between about 88 GPa and about 91 GPa.

The Young's modulus may then be used to determine the specific modulus. It is desirable to have a specific modulus as high as possible to achieve a lightweight composite material that adds stiffness to the final article. Specific modulus is important in applications where stiffness of the product is an important parameter, such as in wind energy and aerospace applications. As used herein, the specific modulus is calculated by the following equation:

$$Specific Modulus ( MJ / kg ) = Modulus ( GPa ) / Density ( kg / cubic meter )$$

The glass fibers may have a specific modulus from about 32.0 MJ/kg to about 37.0 MJ/kg, including about 33 MJ/kg to about 36 MJ/kg, and about 33.5 MJ/kg to about 35.5 MJ/kg.

The density of the glass fibers may be measured by any method known and commonly accepted in the art, such as the Archimedes method (ASTM C693-93 (2008)) on unannealed bulk glass. The glass fibers have a density of from about 2.0 to about 3.0 g/cc. In other aspects, the glass fibers have a density of from about 2.3 to about 2.8 g/cc, including from about 2.4 to about 2.7 g/cc, and about 2.5 to about 2.65 g/cc.

A variety of glass compositions may exhibit the properties set forth above. For example, the glass composition can include from about 55.0 wt. % to about 65.0 wt. % SiO₂, from about 17.0 wt. % to about 27.0 wt. % Al₂O₃, from about 8.0 wt. % to about 15.0 wt. % MgO, from about 7.0 wt. % to about 12 wt. % CaO, from 0.0 wt. % to about 1.0 wt. % Na₂O, from 0.0 wt. % to about 2.0 wt. % TiO₂, from 0 wt. % to about 2.0 wt. % Fe₂O₃, and no more than 0.5 wt. % Li₂O. In aspects, the ratio of the weight percent of alumina oxide and magnesium oxide (Al₂O₃/MgO) is no greater than 2.0, such as no greater than 1.9 or no greater than 1.8. The ratio of the weight percent of magnesium oxide to calcium oxide (MgO/CaO) is, in aspects, at least 1.2.

In some aspects, the glass composition may comprise from about 57.0 wt. % to about 62.0 wt. % SiO₂, from about 19.0 wt. % to about 25.0 wt. % Al₂O₃, from about 10.5 wt. % to about 14.0 wt. % MgO, from about 7.5 wt. % to about 10.0 wt. % CaO, from about 0.0 wt. % to about 0.5 wt. % Na₂O, from about 0.2 wt. % to about 1.5 wt. % TiO₂, from 0 wt. % to about 1.0 wt. % Fe₂O₃, and no more than about 0.1 wt. % Li₂O. The glass composition may have an Al₂O₃/MgO ratio of less than 2 and an MgO/CaO ratio of at least 1.25.

The glass composition may comprise from about 57.5 wt. % to about 60.0 wt. % SiO₂, from about 19.5 wt. % to about 21.0 wt. % Al₂O₃, from about 11.0 wt. % to about 13.0 wt. % MgO, from about 8.0 wt. % to about 9.5 wt. % CaO, from about 0.02 wt. % to about 0.25 wt. % Na₂O, from about 0.5 wt. % to about 1.2 wt. % TiO₂, from 0 wt. % to about 0.5 wt. % Fe₂O₃, and no more than about 0.05 wt. % Li₂O. The glass composition may have an Al₂O₃/MgO ratio of no greater than 1.8 and an MgO/CaO ratio of at least 1.25.

The glass composition includes at least 55 wt. %, but no greater than 65 wt. % SiO₂. When the glass composition includes greater than 65 wt. % SiO₂, the viscosity of the glass can increase to unfavorable levels. Moreover, including less than 55 wt. % SiO₂ can increase the liquidus temperature and crystallization tendency, which can, in turn, require increased processing temperatures. Accordingly, the glass composition can include at least 57 wt. % SiO₂, at least 57.5 wt. % SiO₂, at least 58 wt. % SiO₂, at least 58.5 wt. % SiO₂, or at least 59 wt. % SiO₂. In some aspects, the glass composition includes no greater than 60.5 wt. % SiO₂, no greater than 60.3 wt. % SiO₂, no greater than 60.2 wt. % SiO₂, no greater than 60 wt. % SiO₂, no greater than 59.8 wt. % SiO₂, or no greater than 59.5 wt. % SiO₂.

To achieve both the desired mechanical and fiberizing properties, one important aspect of the glass composition is having a Al₂O₃ concentration of at least 19.0 wt. % and no greater than 27 wt. %. Including less than 19 wt. % Al₂O₃ forms a glass fiber with an unfavorably low modulus. In some aspects, the glass composition includes at least 19.5 wt. % Al₂O₃, at least 19.7 wt. % Al₂O₃, at least 20 wt. % Al₂O₃, at least 20.25 wt. % Al₂O₃, or at least 20.5 wt. % Al₂O₃.

The glass composition advantageously includes at least 8.0 wt. % and no greater than 15 wt. % MgO. Including greater than 15 wt. % MgO will cause the liquidus temperature to increase, which also increases the glass's crystallization tendency. In some aspects, the glass composition includes at least 9.5 wt. % MgO, at least 10 wt. % MgO, at least 10.5 wt. % MgO, at least 11 wt. % MgO, at least 11.10 wt. % MgO, at least 11.25 wt. % MgO, at least 12.5 wt. % MgO, or at least 13 wt. % MgO.

The glass composition may include an Al₂O₃/MgO ratio of no greater than 2.0, such as no greater than 1.9, and no greater than 1.85.

The glass composition advantageously includes at least 7.0 wt. % and no greater than 12 wt. % CaO. In some aspects, the glass composition includes at least 8.0 wt. % CaO, at least 8.3 wt. % CaO, at least 8.5 wt. % CaO, at least 8.7 wt. % CaO, or at least 9.0 wt. % CaO.

In some aspects, the combined amounts of SiO₂, Al₂O₃, MgO, and CaO is at least 98 wt. %, or at least 99 wt. %, and no greater than 99.5 wt. %. In some exemplary embodiments, the combined amounts of SiO₂, Al₂O₃, MgO, and CaO is between 98.3 wt. % and 99.5 wt. %, between 98.5 wt. % and 99.4 wt. %, or between 98.7 wt. % and 99.3 wt. %.

In aspects, the total concentration of MgO and CaO is at least 10 wt. % and no greater than 22 wt. %, such as between 13 wt. % and 21.8 wt. % or between 14 wt. % and 21.5 wt. %. In some aspects, the total concentration of MgO and CaO is at least 20 wt. %.

The glass composition may include up to about 2.0 wt. % TiO₂. In some aspects, the glass composition includes about 0.01 wt. % to about 1.0 wt. % TiO₂, about 0.1 wt. % to about 0.8 wt. % TiO₂, or about 0.2 wt. % to about 0.7 wt. % TiO₂.

The glass composition may include up to about 2.0 wt. % Fe₂O₃. In some aspects, the glass composition includes about 0.01 wt. % to about 1.0 wt. % Fe₂O₃, about 0.05 wt. % to about 0.6 wt. % Fe₂O₃, or about 0.1 wt. % to about 0.5 wt. % Fe₂O₃.

The glass composition may include less than 2.0 wt. % of the alkali metal oxides Na₂O and K₂O, including between 0 wt. % and 1.5 wt. %. The glass composition may advantageously include both Na₂O and K₂O in an amount greater than 0.01 wt. % of each oxide. In some aspects, the glass composition includes about 0 wt. % to about 1 wt. % Na₂O, about 0.01 wt. % to about 0.5 wt. % Na₂O, about 0.03 wt. % to about 0.3 wt. % Na₂O, or 0.04 wt. % to about 0.1 wt. % Na₂O. In some aspects, the glass composition includes about 0 wt. % to about 1 wt. % K₂O, about 0.01 wt. % to about 0.5 wt. % K₂O, about 0.03 wt. % to about 0.3 wt. % K₂O, or about 0.04 wt. % to about 0.1 wt. % K₂O.

As used herein, the terms “weight percent,” “% by weight,” “wt. %,” and “percent by weight” may be used interchangeably and are meant to denote the weight percent (or percent by weight) based on the total composition.

The glass fibers may also be essentially lithium free. By “essentially lithium free,” it is meant that lithium is not intentionally added and the glass composition includes no greater than 5.0 wt. % of lithium, including no greater than 4.0 wt. %, 3.0 wt. %, 2.0 wt. %, 1.0 wt. %, 0.5 wt. %, and 0.1 wt. %. In some aspects, the glass composition includes between 0 and 1.0 wt. % lithium, including between 0 and 0.5 wt. % and between 0 and 0.05 wt. %. In some aspects, the glass composition is entirely free of lithium.

The glass compositions may be free or substantially free of B₂O₃ and fluorine, although either, or any, may be added in small amounts to adjust the fiberizing and finished glass properties and will not adversely impact the properties if maintained below several percent. As used herein, substantially free of B₂O₃, Li₂O, and fluorine means that the sum of the amounts of B₂O₃, Li₂O, and fluorine present is less than 1.0 wt. % of the composition. The sum of the amounts of B₂O₃, Li₂O, and fluorine present may be less than about 0.5 wt. % of the composition, including less than about 0.2 wt. %, less than about 0.1 wt. %, and less than about 0.05 wt. %.

The glass composition may further include impurities and/or trace materials without adversely affecting the glasses or the fibers. These impurities may enter the glass as raw material impurities or may be products formed by the chemical reaction of the molten glass with furnace components. Non-limiting examples of trace materials include zinc, strontium, barium, and combinations thereof. The trace materials may be present in their oxide forms and may further include fluorine and/or chlorine. In some aspects, the glass compositions contain less than 1.0 wt. %, including less than 0.5 wt. %, less than 0.2 wt. %, and less than 0.1 wt. % of each of BaO, SrO, ZnO, ZrO₂, P₂O₅, and SO₃. Particularly, the glass composition may include less than about 5.0 wt. % of BaO, SrO, ZnO, ZrO₂, P₂O₅, and/or SO₃ combined, wherein each of BaO, SrO, ZnO, ZrO₂, P₂O₅, and SO₃ if present at all, is present in an amount of less than 1.0 wt. %.

Preferably, the glass fibers are as described in U.S. Pat. No. 11,214,512, the disclosure of which is fully incorporated herein by reference.

The glass fibers used to form the nonwoven fiber mats may have a variety of fiber diameters. The glass fibers used to form the nonwoven facers have an average fiber diameter of 5.5 microns to 25 microns. In certain aspects, the glass fibers used to form the non-woven fiber mats have an average fiber diameter of 3 microns to 23 microns, including average fiber diameters of 6 microns to 16 microns, 13 microns to 16 microns, or 11 microns to 13 microns. It is also contemplated that a blend of glass fibers having different fiber diameters, such as a blend of smaller diameter glass fibers (e.g., average fiber diameter of 5.5 microns to 10 microns) and larger diameter glass fibers (e.g., average fiber diameter of 13 microns to 16 microns), may be used to form the nonwoven fiber mats.

The glass fibers used to form the nonwoven fiber mats may also have a variety of fiber lengths. In certain embodiments, the glass fibers used to form the nonwoven fiber mats have an average fiber length of 6.35 mm to 50.8 mm. In certain embodiments, the glass fibers have an average fiber length of 12.7 mm to 38.1 mm. In certain other embodiments, the glass fibers have an average fiber length of 19.05 mm to 25.4 mm. In various exemplary embodiments, the glass fibers have an average length of 25.4 mm to 45 mm or 30 mm to 40 mm. It is also contemplated that a blend of glass fibers having different fiber lengths, such as a blend of shorter glass fibers (e.g., average fiber length of 6.35 mm to 12.7 mm) and longer glass fibers (e.g., average fiber length of 19.05 mm to 31.75 mm), may be used.

The glass composition can be used to form glass fibers that are then formed into a nonwoven mat according to known and conventional processes. For example, the method may comprise: a) depositing an aqueous fiber slurry onto a processing line to form a wet laid mat having a first major surface and a second major surface; b) applying a binder composition to at least one of the first major surface and the second major surface of the wet laid mat; and c) heating the wet laid mat to cure the binder composition, thereby forming the nonwoven mat. In various aspects, the fibers are provided to a conveying apparatus such as a conveyor by a storage container for delivery to a mixing tank that contains various surfactants, viscosity modifiers, defoaming agents, and/or other chemical agents with agitation to disperse the fibers and to form an aqueous fiber slurry.

The fiber slurry is deposited onto a processing line to form a wet laid mat having a first major surface and a second major surface. The processing line may be any suitable formation apparatus capable of forming a wet laid mat including, but not limited to, a moving screen or forming wire on an inclined wire forming machine, wire cylinders, Fourdrinier machines, Stevens former, Roto former, Inver former, or Venti former machines. While on the processing line, a substantial portion of the water from the fiber slurry is removed to form a wet laid mat of enmeshed, randomly oriented fibers. The water may be removed from the wet laid mat by a conventional vacuum or air suction system.

The binder composition may be applied to the wet laid mat using a suitable application method including, but not limited to, a binder wire, a spray applicator, a curtain coater, and a Foulard applicator.

Any conventional binder composition used to form nonwoven fiber mats may be used to form the non-woven mats of the present disclosure. In certain embodiments, the binder composition comprises a binder resin material, a coupling agent, and one or more optional additives. The binder resin may be a thermoset material, a thermoplastic material, or a mixture of a thermoset material and a thermoplastic material. In some aspects, the binder resin material comprises any of a latex material, an elastomeric material, acrylic material, styrene-acrylic material, styrene butadiene, a urea formaldehyde material, a melamine formaldehyde material, epoxy, polyurethane, or a combination of the two materials. The acrylic material may comprise polyacrylic acid, such as low molecular weight polyacrylic acid with a weight average molecular weight at or below 10,000 Daltons.

In some aspects, the binder resin material may comprise a blend of urea formaldehyde and a thermoset or thermoplastic acrylic. The thermoset acrylic may comprise an acrylic homopolymer or copolymer. The urea formaldehyde may be present in the binder resin material in an amount from about 70 wt. % to about 95 wt. %, based on the total weight of the binder resin material, including between about 78 wt. % and 92 wt. %, and between about 80 wt. % and about 90 wt. %. The thermoset acrylic may be present in the binder composition in an amount from about 5 wt. % to about 30 wt. %, based on the total weight of the binder resin material, including between about 7 wt. % and 25 wt. %, and about 10 to about 20 wt. %.

After the binder composition is applied to the wet laid mat, the wet laid mat is heated to remove any residual water and cure the binder composition, thereby forming the nonwoven mat. The step of heating the wet laid mat may be accomplished using any known heating or drying method. Suitable heating methods that may be used in the method of the present disclosure include, but are not limited to, a rotary/thru air dryer or oven, a heated drum dryer, an infrared heating source, a hot air blower, and a microwave emitting source. In aspects, the heating step comprises exposing the wet laid mat having the binder composition applied thereto to a temperature of 150° C. to 250° C. for a time period of up to 45 seconds.

The nonwoven fiber mats of the present disclosure may have a wide range of basis weights (uncoated). For instance, the nonwoven fiber mats may have an uncoated basis weight of 25 g/m² to 300 g/m², such as, for example, nonwoven fiber mats have an uncoated basis weight of 30 g/m² to 200 g/m², 40 g/m² to 150 g/m², 50 g/m² to 125 g/m², 55 g/m² to 115 g/m², and 65 g/m² to 100 g/m². In still other embodiments, the nonwoven fiber mats have an uncoated basis weight of at least 76 g/m² or at least 80 g/m².

### Roofing Materials

The nonwoven glass mat and the asphalt coating composition can be used in the manufacture of shingles and other roofing products, such as roofing underlayments, membranes, roll roofing, and the like. Asphalt-based roofing products are installed on the roofs of buildings to provide protection from the elements and to give the roof an aesthetically pleasing look. In aspects in which the asphalt composition is a coating on a roofing material, the asphalt composition may be applied to at least a portion of the nonwoven mat.

A conventional roofing shingle is typically constructed of a substrate (e.g., a nonwoven mat as described hereinabove), an asphalt coating composition that saturates the substrate and forms a layer of asphalt coating on a top surface and a bottom surface of the substrate, a decorative/protective layer of granules applied to the asphalt coating on the top surface of the substrate, and optionally, a layer of sand or other parting agent applied to the asphalt coating on the bottom surface of the substrate in accordance with ASTM D3462. The asphalt coatings are generally formed from a layer of hot, melted asphalt composition applied to the substrate. The asphalt coating can be applied to the substrate in any suitable manner. For example, the substrate can be submerged in the asphalt composition or the asphalt composition can be rolled on, sprayed on, or applied to the substrate by other means.

As a result of the glass fibers having a toughness of greater than 45 kPa/(kg/m³), the resulting shingle exhibits an improvement in cross-direction (CD) tear resistance of at least 100 grams-force, as compared to an otherwise identical shingle having a nonwoven mat comprising a plurality of glass fibers having a specific toughness of less than 45 kPa/(kg/m³). CD tear resistance is measured in accordance with ASTM D1922, as modified by ASTM D228. In aspects, the roofing shingle exhibits an improvement in CD tear resistance of at least 150 grams-force, at least 200 grams-force, or even at least 250 grams-force, as compared to an otherwise identical shingle having a nonwoven mat comprising a plurality of glass fibers having a specific toughness of less than 45 kPa/(kg/m³).

In aspects, the resulting shingle exhibits an improvement in cross-direction (CD) tear resistance of at least 5%, as compared to an otherwise identical shingle having a nonwoven mat comprising a plurality of glass fibers having a specific toughness of less than 45 kPa/(kg/m³). For example, the roofing shingle can exhibit an improvement in CD tear resistance of at least 7.5% or at least 10%, as compared to an otherwise identical shingle having a nonwoven mat comprising a plurality of glass fibers having a specific toughness of less than 45 kPa/(kg/m³).

In aspects, the resulting shingle exhibits a cross-direction (CD) tear resistance of greater than or equal to about 1,800 grams-force. For example, the roofing shingle can exhibit a CD tear resistance of greater than or equal to about 1,850 grams-force, greater than or equal to about 1,900 grams-force, greater than or equal to about 1,950 grams-force, or even greater than or equal to about 2,000 grams-force.

The roofing shingle of various aspects may also exhibit an improvement in stiffness of at least 5%, as compared to an otherwise identical shingle having a nonwoven mat comprising a plurality of glass fibers having a specific toughness of less than 45 kPa/(kg/m³). As used herein, stiffness is measured by dynamic mechanical analysis using a dual cantilever clamp at a frequency of 1 Hz with deformation of 10 μm and at a temperature of 25° C. In aspects, the roofing shingle exhibits an improvement in stiffness of at least 7.5% or at least 10% as compared to an otherwise identical shingle having a nonwoven mat comprising a plurality of glass fibers having a specific toughness of less than 45 kPa/(kg/m³).

The use of glass fibers having a specific toughness of greater than or equal to 45 kPa/(kg/m³) can also provide a roofing shingle having a Gurley stiffness of greater than or equal to 9,000 mg-f, as measured in accordance with Tappi standard T543 on unnotched specimens in either the machine direction (MD) or cross-direction (CD). The improvement in Gurley stiffness may be quantified as an improvement in cross-direction Gurley stiffness of greater than or equal to 5% as compared to an otherwise identical shingle having a nonwoven mat comprising a plurality of glass fibers having a specific toughness of less than 45 kPa/(kg/m³).

The use of glass fibers having a specific toughness of greater than or equal to 45 kPa/(kg/m³) can also provide a roofing shingle having a nail pull through strength of greater than or equal to 20.5 lbf, as measured in accordance with ASTM D3462 at 73° F. For example, the roofing shingle may have a nail pull through strength of greater than or equal to 21 lbf, greater than or equal to 22 lbf, greater than or equal to 23 lbf, greater than or equal to 24 lbf, or even greater than or equal to 25 lbf. The improvement in nail pull through strength may be quantified as an improvement in nail pull through strength of greater than or equal to 15% as compared to an otherwise identical shingle having a nonwoven mat comprising a plurality of glass fibers having a specific toughness of less than 45 kPa/(kg/m³). For example, the roofing shingle may exhibit an improvement in nail pull through strength of greater than or equal to 15%, greater than or equal to 18%, or even greater than or equal to 20%, as compared to an otherwise identical shingle having a nonwoven mat comprising a plurality of glass fibers having a specific toughness of less than 45 kPa/(kg/m³).

The use of glass fibers having a specific toughness of greater than or equal to 45 kPa/(kg/m³) can also provide a roofing shingle having a nail pull through strength of greater than or equal to 24.0 lbf, as measured in accordance with ASTM D3462 at 32° F. For example, the roofing shingle may have a nail pull through strength of greater than or equal to 24.0 lbf, greater than or equal to 24.5 lbf, or even greater than or equal to 25.0 lbf. The improvement in nail pull through strength may be quantified as an improvement in nail pull through strength of greater than or equal to 5% as compared to an otherwise identical shingle having a nonwoven mat comprising a plurality of glass fibers having a specific toughness of less than 45 kPa/(kg/m³).

The use of glass fibers having a specific toughness of greater than or equal to 45 kPa/(kg/m³) can also provide a roofing shingle having a Charpy impact resistance of greater than or equal to 0.20 ft-lbf, as measured in accordance with ASTM D6110 in the cross-direction at 73° F. on unnotched specimens. For example, the roofing shingle may have a Charpy impact resistance of greater than or equal to 0.20 ft-lbf, greater than or equal to 0.22 ft-lbf, greater than or equal to 0.24 ft-lbf, greater than or equal to 0.26 ft-lbf, greater than or equal to 0.28 ft-lbf, or even greater than or equal to 0.30 ft-lbf. The improvement in Charpy impact resistance may be quantified as an improvement in Charpy impact resistance of greater than or equal to 20% as compared to an otherwise identical shingle having a nonwoven mat comprising a plurality of glass fibers having a specific toughness of less than 45 kPa/(kg/m³), including greater than or equal to 30%, greater than or equal to 35%, greater than or equal to 40%, greater than or equal to 45%, greater than or equal to 50%, greater than or equal to 55%, or even greater than or equal to 60%.

The use of glass fibers having a specific toughness of greater than or equal to 45 kPa/(kg/m³) can also provide a roofing shingle having a machine direction (MD) tensile strength of greater than or equal to 160 lbf, as measured according to a modified ASTM D828 on a 2-inch wide by 10-inch long sample tested at 2 inches per minute. For example, the roofing shingle may have a MD tensile strength of greater than or equal to 160 lbf, greater than or equal to 165 lbf, or even greater than or equal to 170 lbf. The improvement in MD tensile strength may be quantified as an improvement in MD tensile strength of greater than or equal to 5% as compared to an otherwise identical shingle having a nonwoven mat comprising a plurality of glass fibers having a specific toughness of less than 45 kPa/(kg/m³), including an improvement in MD tensile strength of greater than or equal to 7%, greater than or equal to 10%, greater than or equal to 12%, greater than or equal to 15%, or even greater than or equal to 17%.

In aspects, the use of glass fibers having a specific toughness of greater than or equal to 45 kPa/(kg/m³) can also provide a roofing shingle having an improved impact resistance as measured under UL2218. For example, the use of glass fibers having a specific toughness of greater than or equal to 45 kPa/(kg/m³) can also provide a roofing shingle having an improved impact resistance as measured under UL2218 of greater than or equal to 5% as compared to an otherwise identical shingle having a nonwoven mat comprising a plurality of glass fibers having a specific toughness of less than 45 kPa/(kg/m³), including an improvement impact resistance as measured under UL2218 of greater than or equal to 7%, greater than or equal to 10%, greater than or equal to 12%, greater than or equal to 15%, or even greater than or equal to 17%.

The nonwoven mat may also be disposed on the asphalt coating composition, which may at least partially extend into the nonwoven mat to form a roofing underlayment. In such aspects, the asphalt coating composition may be referred to as an “asphalt layer” or “asphalt batch layer.” The use of a nonwoven mat formed from a plurality of glass fibers having a specific toughness of less than 45 kPa/(kg/m³) can provide improvements to one or more properties in roofing underlayment.

As a result of the glass fibers having a toughness of greater than 45 kPa/(kg/m³), the resulting roofing underlayment exhibits an improvement in cross-direction (CD) tear resistance of at least 15%, as compared to an otherwise identical roofing underlayment having a nonwoven mat comprising a plurality of glass fibers having a specific toughness of less than 45 kPa/(kg/m³). CD tear resistance of a roofing underlayment is measured in accordance with ASTM D1970.

In aspects, the resulting roofing underlayment exhibits an improvement in machine-direction (MD) tear resistance of at least 15%, as compared to an otherwise identical roofing underlayment having a nonwoven mat comprising a plurality of glass fibers having a specific toughness of less than 45 kPa/(kg/m³). MD tear resistance of a roofing underlayment is measured in accordance with ASTM D1970.

The roofing underlayment may further exhibit an improvement in machine-direction (MD) tensile elongation of at least 30%, as compared to an otherwise identical roofing underlayment having a nonwoven mat comprising a plurality of glass fibers having a specific toughness of less than 45 kPa/(kg/m³). MD tensile elongation of a roofing underlayment is measured in accordance with ASTM D1970.

The roofing underlayment may further exhibit an improvement in cross-direction (CD) tensile elongation of at least 15%, as compared to an otherwise identical roofing underlayment having a nonwoven mat comprising a plurality of glass fibers having a specific toughness of less than 45 kPa/(kg/m³). CD tensile elongation of a roofing underlayment is measured in accordance with ASTM D1970.

### EXAMPLES

### Example 1

In order to identify the impact of the specific toughness of glass used in a nonwoven mat used in a shingle on the CD tear performance of a shingle, shingle prototypes were prepared using four different types of glass where one of the glasses (Sample A) had a specific toughness below 45 kPa/(kg/m³) and the other three glasses (Samples B-D) had a specific toughness above 45 kPa/(kg/m³). Each of the samples had a basis weight of 1.75 lb/ft². Properties of the glass fibers and the % improvement in CD tear resistance of as compared to an otherwise identical shingle including the glass of Sample A are provided in Table 1. CD tear resistance was measured in grams-force in accordance with ASTM D1922, as modified by ASTM D228.

TABLE 1

| | | | |
|---|---|---|---|
| Sample A | Sample B | Sample C | Sample D |

Glass

| | | | | |
|---|---|---|---|---|
| Specific | 1.52 | 1.76 | 2.18 | 1.83 |
| Strength | | | | |
| (MPa/(kg/m³)) | | | | |
| Specific | 30.9 | 33.6 | 35.8 | 34.9 |
| Modulus | | | | |
| (MJ/kg) | | | | |
| Specific | 37.3 | 46.2 | 66.5 | 48.0 |
| Toughness | | | | |
| (kPa/(kg/m³)) | | | | |

Shingle CD Tear

| | | | | |
|---|---|---|---|---|
| % Improvement | — | 24.5% | 68% | 11% |
| over Sample A | | | | |

As shown in Table 1, Samples B-D, which included glass fibers having a specific toughness of above 45 kPa/(kg/m³) each exhibits an improvement in CD tear resistance as compared to the comparative glass formulation that has a specific toughness of below 45 kPa/(kg/m³) (Sample A).

### Example 2

Further samples were prepared using the glass used in Sample A above (Sample E), another glass having a specific toughness of below 45 kPa/(kg/m³) (Sample F) and an additional glass having a specific toughness of above 45 kPa/(kg/m³) (Sample G). Each of the samples had a basis weight of 1.75 lb/ft². Properties of each of the glass, the nonwoven mat, and the shingle prototype were measured and are reported in Table 2 below. CD tear resistance was measured in grams-force according to ASTM D1922, as modified by ASTM D228. MD Tensile strength was measured in lbf according to a modified ASTM D828 on a 2-inch wide by 10-inch long sample tested at 2 inches per minute. Nail pull strength was measured in lbf in accordance with ASTM D3462 at 32° F. and 73° F. Gurley stiffness was measured in accordance with Tappi standard T543. Gurley stiffness was measured in milligrams-force (mg-f), and the nonwoven mat was cut into samples 4.5 inches long by 2 inches wide with five replicates per set point. For each test for Samples F and G, a second value is reported as a % as compared to the values for Sample E.

TABLE 2

| | | |
|---|---|---|
| Sample E | Sample F | Sample G |

Glass

| | | | |
|---|---|---|---|
| Specific Strength | 1.52 | 1.75 | 1.79 |
| | | 15.1% | 17.8% |
| Specific Modulus | 30.9 | 34.9 | 34.0 |
| | | 12.9% | 10.0% |
| Specific Toughness | 37.3 | 43.9 | 47.0 |
| (kPa/(kg/m³)) | | 17.7% | 26.0% |

Nonwoven Mat

| | | | |
|---|---|---|---|
| MD Tensile (lbf) | 74.3 | 67.8 | 79.8 |
| | | −8.7% | 7.4% |
| CD Tear (grams- | 589.0 | 613.0 | 641.1 |
| force) | | 4.1% | 8.8% |
| MD Gurley Stiffness | 3729.0 | 3772.0 | 4224.0 |
| (mg-f) | | 1.2% | 13.3% |
| CD Gurley Stiffness | 4090.0 | 4293.0 | 4279.0 |
| (mg-f) | | 5.0% | 4.6% |

Shingle

| | | | |
|---|---|---|---|
| CD Tear (grams- | 1467.0 | 1489.0 | 1685.0 |
| force) | | 1.4% | 14.8% |
| MD Tensile (lbf) | 145.0 | 155.0 | 171.0 |
| | | 6.9% | 17.9% |
| Nail Pull (73° F.) (lbf) | 20.0 | 20.2 | 24.6 |
| | | 1.0% | 23% |
| Nail Pull (32° F.) (lbf) | 23.8 | 22.6 | 25.4 |
| | | −5.0% | 6.7% |

As shown in Table 2, although both Samples F and G employed glass fibers having increased specific strength, specific modulus, and specific toughness as compared to the glass fiber of Sample E, the specific toughness of Sample G yielded a significant improvement in CD tear resistance that was not observed in Sample F. Sample G also exhibited significant improvement in both MD tensile strength and nail pull strength as compared to both of Samples E and F.

Further samples were prepared using the glass used in Sample E above (Sample H) the glass used in Sample G above (Sample I). Each of the samples had a basis weight of 1.55 lb/ft². Properties of each of the glass, the nonwoven mat, and the shingle prototype were measured and are reported in Table 3 below. For each test for Sample I, a second value is reported as a % as compared to the values for Sample H. DMA Stiffness was measured in N/m by dynamic mechanical analysis using a dual cantilever clamp at a frequency of 1 Hz with deformation of 10 μm and at a temperature of 25° C. Charpy Impact was measured in ft-lbf in accordance with ASTM D6110 in the cross-direction at 73° F. on unnotched specimens.

TABLE 3

| | |
|---|---|
| Sample H | Sample I |

Nonwoven Mat

| | | |
|---|---|---|
| MD Tensile (lbf) | 68.0 | 69.8 |
| % Improvement over Sample H | — | 2.6% |
| CD Tear (grams-force) | 461.0 | 764.0 |
| % Improvement over Sample H | — | 65.7% |
| MD Gurley Stiffness (mg-f) | 2302.0 | 2551.0 |
| % Improvement over Sample H | — | 10.8% |
| CD Gurley Stiffness (mg-f) | 2187.0 | 3369.0 |
| % Improvement over Sample H | — | 54.0% |

Shingle

| | | |
|---|---|---|
| DMA Stiffness (N/m) | 12,436.00 | 14,000.00 |
| % Improvement over Sample H | — | 12.6% |
| Charpy Impact (ft-lbf) | 0.18 | 0.30 |
| % Improvement over Sample H | — | 66% |

As shown in Table 3, the specific toughness of Sample 1 yielded a significant improvement in Charpy impact resistance as well as an improvement in DMA stiffness.

Moreover, by comparing the values for the nonwoven mat, it can be seen that, although there were differences in the properties of the nonwoven mat, these properties did not correlate with the final properties of the shingle prototype.

### Example 3

A plant trial was conducted in which shingles were prepared using either a nonwoven mat prepared from a glass composition having a specific toughness of above 45 kPa/(kg/m³) (Sample J) or the glass composition used in Samples A and E above (e.g., a glass composition having a specific toughness of 37.3 kPa/(kg/m³); Sample K). CD tear resistance and MD tensile strength was measured for the shingles prepared and the average is reported in Table 4 below. CD tear resistance was measured in grams-force according to ASTM D1922, as modified by ASTM D228. The value reported in Table 4 is an average for two plant trials. MD Tensile strength was measured in lbf according to a modified ASTM D828 on a 2-inch wide by 10-inch long sample tested at 2 inches per minute. Nail pull strength was measured in lbf in accordance with ASTM D3462 at 32° F. and 73° F.

TABLE 4

| | Sample J | Sample K |
|---|---|---|
| CD Tear (grams-force) | 2151 | 1866 |
| % Improvement over Sample K | 15.3% | — |
| MD Tensile (lbf) | 224.7 | 197.3 |
| % Improvement over Sample K | 13.9% | — |
| Nail Pull (73° F.) (lbf) | 56.1 | 50.72 |
| % Improvement over Sample K | 10.6% | — |
| Nail Pull (32° F.) (lbf) | 68.73 | 61.23 |
| % Improvement over Sample K | 12.2% | — |

Accordingly, as shown in Table 4, the use of glass fibers having a specific toughness of above 45 kPa/(kg/m³) is effective to produce a shingle having an improved CD tear resistance and MD tensile strength as compared to an otherwise identical shingle including glass fibers having a specific toughness of less than 45 kPa/(kg/m³).

### Example 4

Roofing underlayments were prepared by at least partially impregnating an asphalt composition into a nonwoven mat. The nonwoven mat was formed using either the glass used in Sample A above (e.g., a glass composition having a specific toughness of 37.3 kPa/(kg/m³); Sample L) or the glass used in Sample G above (e.g., a glass composition having a specific toughness of 47.0 kPa/(kg/m³); Sample M). Various properties of the roofing underlayments are provided in Table 5 below.

MD Notched Tear Resistance and CD Notched Tear Resistance are reported in grams-force. MD Tensile Strength and CD Tensile Strength are reported in lbf. MD Elongation and CD Elongation are reported in percent (%). All of MD Notched Tear, CD Notched Tear, MD Tensile, CD Tensile, MD Elongation, and CD Elongation are measured in accordance with ASTM D1970. MD Gurley Stiffness and CD Gurley Stiffness were measured in accordance with Tappi standard T543. Gurley stiffness was measured in milligrams-force (mg-f), and the nonwoven mat was cut into samples 4.5 inches long by 2 inches wide with five replicates per set point.

Saturation is reported in pixels detected by the imaging software as white within the area being measured. Saturation was measured using a Keyence imaging system. The non-coated side of the glass mat is placed face up with the camera looking down from above. The camera is then seeing the side of the glass mat that was not directly coated with core batch asphalt. The Keyence software is set to Black & White detection and registers the pixels seeing asphalt as black and the pixels seeing exposed glass fibers as white. The value recorded is the number of white pixels the software detects. The higher the value, the more glass is still exposed, meaning the asphalt did not fully penetrate and saturate the glass mat in those areas. Lower value equates to more asphalt saturating the glass mat.

For Sample M, the % improvement as compared to the value of Sample L is also reported.

TABLE 5

| | | Sample M | |
|---|---|---|---|
| | Sample L | Reported Value | % Improvement |
| MD Notched Tear | 93.7 | 119.01 | 27.0% |
| (grams-force) | | | |
| CD Notched Tear | 82.43 | 104.76 | 27.1% |
| (grams-force) | | | |
| MD Tensile (lbf) | 87.81 | 93.80 | 6.8% |
| CD Tensile (lbf) | 63.71 | 75.43 | 18.4% |
| MD Elongation (%) | 7.85 | 11.33 | 44.4% |
| CD Elongation (%) | 11.84 | 14.03 | 18.5% |
| MD Gurley Stiffness | 8,710.05 | 9,047.80 | 3.9% |
| (mg-f) | | | |
| CD Gurley Stiffness | 8,616.70 | 9,296.85 | 7.9% |
| (mg-f) | | | |
| Saturation - B/W area | 74,028.95 | 26,240.40 | −64.6% |

As shown in Table 5, the use of glass fibers having a specific toughness of above 45 kPa/(kg/m³) provided a roofing underlayment having an improved tear resistance (CD and MD), tensile strength (CD and MD), and elongation (CD and MD) as compared to an otherwise identical roofing underlayment including glass fibers having a specific toughness of less than 45 kPa/(kg/m³). An improvement in the Gurley stiffness of the roofing underlayment was also observed. Moreover, the use of glass fibers having a specific toughness of above 45 kPa/(kg/m³) increased the saturation of the roofing underlayment as compared to an otherwise identical roofing underlayment including glass fibers having a specific toughness of less than 45 kPa/(kg/m³).

To the extent not already described, the different features and structures of the various embodiments of the present disclosure may be used in combination with each other as desired. For example, one or more of the features illustrated and/or described with respect to one aspect of the disclosure can be used with or combined with one or more features illustrated and/or described with respect to other aspects of the disclosure. That one feature may not be illustrated in all of the embodiments is not meant to be construed that it cannot be, but is done for brevity of description. Thus, the various features of the different embodiments may be mixed and matched as desired to form new embodiments, whether or not the new embodiments are expressly described.

While aspects of the present disclosure have been specifically described in connection with certain specific embodiments thereof, it is to be understood that this is by way of illustration and not of limitation. Reasonable variation and modification are possible within the scope of the forgoing disclosure without departing from the spirit of the present disclosure which is defined in the appended claims.

What is claimed is:

1. A roofing shingle comprising:
a nonwoven mat comprising a plurality of glass fibers having a specific toughness greater than or equal to 45 kPa/(kg/m³) bound together by a binder; and
an asphalt shingle coating composition applied to at least one side of the nonwoven mat,
wherein the roofing shingle has an improvement in cross-direction (CD) tear resistance, as measured in accordance with ASTM D1922 as modified by ASTM D228, of at least 5% as compared to an otherwise identical shingle having a nonwoven mat comprising a plurality of glass fibers having a specific toughness of less than 45 kPa/(kg/m³).

2. The roofing shingle according to claim 1, wherein the asphalt shingle coating composition comprises non-oxidized asphalt.

3. The roofing shingle according to claim 1, wherein the asphalt shingle coating comprises polymer modified asphalt.

4. The roofing shingle according to claim 1, wherein the plurality of glass fibers have a Young's modulus of at least about 85 GPa.

5. The roofing shingle according to claim 1, wherein the plurality of glass fibers have a specific modulus of from about 32 MJ/kg to about 37 MJ/kg.

6. The roofing shingle according to claim 1, wherein the plurality of glass fibers have a density of from about 2.0 g/cc to about 3.0 g/cc, measured in accordance with ASTM C-693-63.

7. The roofing shingle according to claim 1, wherein the plurality of glass fibers have a specific strength of greater than or equal to about 1.70 MPa/(kg/m³).

8. The roofing shingle according to claim 1, wherein the roofing shingle has a CD tear resistance of greater than or equal to about 2,000 grams-force.

9. The roofing shingle according to claim 1, wherein the roofing shingle has an improvement in stiffness of at least 5%, as measured by dynamic mechanical analysis, as compared to an otherwise identical shingle having a nonwoven mat comprising a plurality of glass fibers having a specific toughness of less than 45 kPa/(kg/m³).

10. The roofing shingle according to claim 1, wherein the roofing shingle has an improvement in stiffness of at least 10%, as measured by dynamic mechanical analysis, as compared to an otherwise identical shingle having a nonwoven mat comprising a plurality of glass fibers having a specific toughness of less than 45 kPa/(kg/m³).

11. The roofing shingle according to claim 1, wherein the roofing shingle has a nail pull through strength of greater than or equal to 20.5 lbf, measured in accordance with ASTM D3462 at 73° F.

12. The roofing shingle according to claim 1, wherein the roofing shingle has an improvement in nail pull through strength of greater than or equal to 15% measured in accordance with ASTM D3462 at 73° F., as compared to an otherwise identical shingle having a nonwoven mat comprising a plurality of glass fibers having a specific toughness of less than 45 kPa/(kg/m³).

13. The roofing shingle according to claim 1, wherein the roofing shingle has an improvement in nail pull through strength of greater than or equal to 20% measured in accordance with ASTM D3462 at 73° F., as compared to an otherwise identical shingle having a nonwoven mat comprising a plurality of glass fibers having a specific toughness of less than 45 kPa/(kg/m³).

14. The roofing shingle according to claim 1, wherein the roofing shingle has an improvement in nail pull through strength of greater than or equal to 5% measured in accordance with ASTM D3462 at 32° F., as compared to an otherwise identical shingle having a nonwoven mat comprising a plurality of glass fibers having a specific toughness of less than 45 kPa/(kg/m³).

15. The roofing shingle according to claim 1, wherein the roofing shingle has an improvement in Charpy impact resistance of greater than or equal to 20% measured in accordance with ASTM D6110 in the cross-direction at 73° F. on unnotched specimens, as compared to an otherwise identical shingle having a nonwoven mat comprising a plurality of glass fibers having a specific toughness of less than 45 kPa/(kg/m³).

16. The roofing shingle according to claim 1, wherein the roofing shingle has an improvement in machine direction (MD) tensile strength of greater than or equal to 5% measured according to a modified ASTM D828 on a 2-inch wide by 10-inch long sample tested at 2 inches per minute, as compared to an otherwise identical shingle having a nonwoven mat comprising a plurality of glass fibers having a specific toughness of less than 45 kPa/(kg/m³).

17. The roofing shingle according to claim 1, wherein the roofing shingle has an improvement in impact resistance of greater than or equal to 5% measured according to UL2218, as compared to an otherwise identical shingle having a nonwoven mat comprising a plurality of glass fibers having a specific toughness of less than 45 kPa/(kg/m³).

18. The roofing shingle according to claim 1, wherein the roofing shingle has an improvement in cross-direction Gurley stiffness of greater than or equal to 5% as compared to an otherwise identical shingle having a nonwoven mat comprising a plurality of glass fibers having a specific toughness of less than 45 kPa/(kg/m³).

19. The use of a nonwoven mat in a roofing shingle, the nonwoven mat comprising a plurality of glass fibers having a specific toughness greater than or equal to 45 kPa/(kg/m³) bound together by a binder.

20. A method of manufacturing a roofing shingle comprising:
applying an asphalt shingle coating composition to at least one surface of a nonwoven mat, thereby forming an asphalt-coated sheet, the nonwoven mat comprising a plurality of glass fibers having a specific toughness greater than or equal to 45 kPa/(kg/m³) bound together by a binder,
wherein the roofing shingle has an improvement in cross-direction (CD) tear resistance, as measured in accordance with ASTM D1922, of at least 5% as compared to an otherwise identical shingle having a nonwoven mat comprising a plurality of glass fibers having a specific toughness of less than 45 kPa/(kg/m³).
